(19) United States
(12) Patent Application Publication
(10) Pub. No.: US 2025/0084600 A1
(43) Pub. Date: Mar. 13, 2025

(54) APPARATUS FOR COLLECTION OF NON-METALLIC AND METALLIC FOREIGN OBJECT DEBRIS

(71) Applicant: Bluestreak Equipment Inc., Delhi (CA)

(72) Inventors: John MAGUIRE, Delhi (CA); Brian WEBER, Delhi (CA)

(21) Appl. No.: 18/827,698

(22) Filed: Sep. 7, 2024

Related U.S. Application Data
(60) Provisional application No. 63/581,627, filed on Sep. 8, 2023.

(51) Int. Cl. E01H 1/04; A46B 5/00; A46B 15/00; B62D 63/06

(52) U.S. Cl. CPC E01H 1/04; A46B 5/0058; A46B 15/001; B62D 63/061; A46B 2200/3066

(57) ABSTRACT

A system and method for collection of non-metallic and metallic foreign object debris (FOD) is disclosed. The foreign object debris system consists of one or more debris collection modules and can be deployed in various width configurations. Debris collection modules can be pulled, pushed, attached to moving equipment, vehicles or to a tow trailer to provide motion. Each pickup module consists of a frame, a debris bin area, a brush, one or more rigid ramp(s) with replaceable tip(s). Multiple debris collection modules can be connected to form a wider or narrower sweeping width. As the foreign object debris system travels forward, debris travels up the tip(s) and ramp(s) and is deposited into a debris bin.

### CROSS REFERENCE TO RELATED APPLICATIONS

This application claims priority to and the benefit of U.S. Provisional Application Ser. No. 63/581,627, entitled “APPARATUS FOR COLLECTION OF NON-METALLIC AND METALLIC FOREIGN OBJECT DEBRIS”, filed on Sep. 8, 2023, the disclosure of which is incorporated herein by reference in its entirety.

### BACKGROUND

The field of the disclosure relates to sweeper apparatus, in particular to a sweeper apparatus for collection of non-metallic and metallic foreign object debris (FOD).

Roads, airfields and other hard surfaces that vehicles, aircraft and equipment travel can become littered with foreign object debris which has the potential to damage vehicles, aircraft and equipment, or in some cases harm people, directly or indirectly. This debris can include but is not limited to tire fragments, rocks, gravel, sand, fasteners, paper, brush bristles, tools, nails, zipper pulls and vehicle parts. The debris can be both metallic and non-metallic.

Vehicles which encounter these larger objects have the potential of damage which could result in a loss of control and endanger the occupants. Similarly jet turbines mounted low on aircraft can ingest the debris and cause expensive damage or possibly harm the occupants. FOD programs exist to collect this dangerous debris using a variety of methods. Large debris can be collected by hand and smaller debris can be collected or pushed away from active areas using brushes or vacuums. Collecting debris by hand on an active roadway can be a dangerous job and an effective tool would be beneficial.

There is a desire for a device configured for collection of foreign object debris. A study at Chicago O'Hare Airport found that by weight only 20% of FOD is metallic and can be collected using a magnet, and that 71% of the debris collected is less than three cubic inches in size.

### BRIEF DESCRIPTION OF THE DRAWINGS

FIG. 1 is a diagram of a perspective view of an exemplary debris collection module.

FIG. 2 is a diagram of a side view of the debris collection module.

FIG. 3 is a diagram of a perspective view of the debris collection module with a cover.

FIG. 4 is a diagram of a perspective view of the debris collection module with the cover open.

FIG. 5 is a diagram of a perspective bottom view of the debris collection module.

FIG. 6 is a diagram of a side view of an exemplary ramp layout.

FIG. 7 is a diagram of a side view of a ramp layout with a sprung tip.

FIG. 8 is a diagram of a perspective view of a ramp assembly.

FIG. 9 is a diagram of a close-up view of the ramp tip connection.

FIG. 10 is a diagram illustrating multiple views of an exemplary front supported tip.

FIG. 11 is a diagram illustrating multiple views of an exemplary large debris tip.

FIG. 12 is a diagram illustrating multiple views of an exemplary sprung tip.

FIG. 13 is a diagram illustrating multiple views of an exemplary unsupported tip.

FIG. 14 is a diagram of a close-up view of the brush pivot detail.

FIG. 15 is a diagram of a close-up view of the brush pivot detail with a wear plate.

FIG. 16 is a diagram of a close-up view of the module connection clip detail.

FIG. 17 is a diagram of a close-up view of the pivoting link to tow trailer.

FIG. 18 is a diagram of a close-up view of connected modules.

FIG. 19 is a diagram of a wide sweeping configuration of a plurality of debris collection modules in operation.

FIG. 20 is a diagram of a narrow sweeping configuration of a plurality of debris collection modules in operation.

FIG. 21 is a diagram of an alternate narrow sweeping configuration of a plurality of debris collection modules in operation.

FIG. 22 is a diagram of a travel configuration of a plurality of debris collection modules.

FIG. 23 is a diagram illustrating an alternate debris collection module design.

FIG. 24 is a diagram illustrating an alternate debris collection module assembly design.

FIG. 25 is a diagram illustrating an alternate embodiment of a small debris system with a large debris system.

FIG. 26 is a diagram illustrating an alternate debris collection module with skid plates.

### SUMMARY

A system and method for collection of non-metallic and metallic foreign object debris (FOD) is disclosed. The foreign object debris system consists of one or more debris collection modules and can be deployed in various width configurations. Debris collection modules can be pulled, pushed, attached to moving equipment, vehicles or to a tow trailer to provide motion. Each pickup module consists of a frame, a debris bin area, a brush, and one or more rigid ramp(s) with replaceable tip(s). Multiple debris collection modules can be connected to form a wider or narrower sweeping width. As the foreign object debris system travels forward, debris travels up the tip(s) and ramp(s) and is deposited into a debris bin.

### DETAILED DESCRIPTION

The purpose of this disclosure is a device is to collect debris that is unsightly or has the potential to damage equipment or endanger life. A debris collection module is disclosed. Each module houses one or more ramp(s) and tip(s) mounted at an angle to the ground surface which when moving forward scoop debris from the surface. A brush is mounted ahead of the ramp(s) and tip(s) to disrupt small debris and cause it to become airborne where the ramps can capture it. Each ramp has a series of rifles to prevent debris from returning to the ground surface. The ramp(s) have replaceable tip(s) to extend the overall lifetime of the device and reduce lifetime costs.

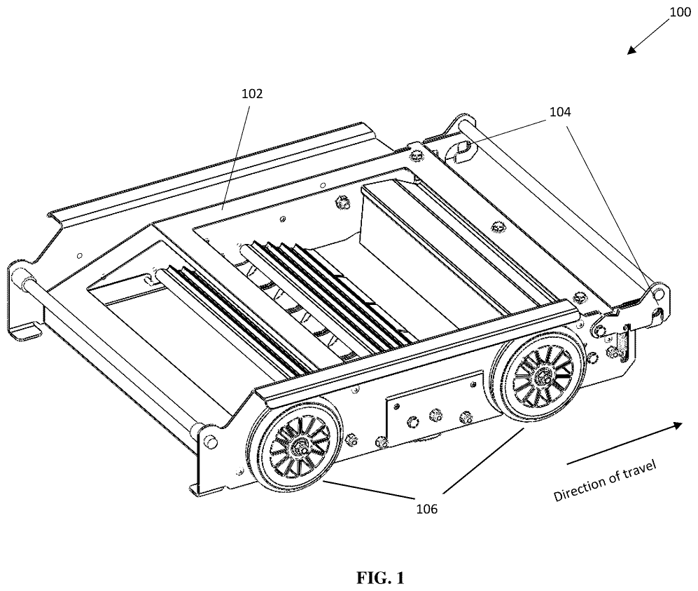

FIG. 1 is a diagram of a perspective view of an exemplary debris collection module. According to FIG. 1, debris collection module 100, has a chassis 102 with dimensions of 22″ width X 20″ length X 4″ height with an approximate weight of 20 lbs. Debris collection module also has module connection clips 104 and wheels 106 that moves in the direction of travel. The module connection clips 104 connect the debris collection module 100 to a tow trailer or to other debris collection modules.

According to FIG. 1, a debris collection module chassis 102 is suspended by wheels 106, and drawn by a module connection clips 104. The wheels 106 allow the debris collection modules to move easily and control the distance ramp tip(s) are from the ground. They also control the amount of downward pressure unsupported ramp tip(s) can exert. The wheels also help to ensure even wear on all wear parts. The module connection clips 104 allow the linking of several modules to each other to provide rigidity and still allow flexibility for surface conformance when being towed.

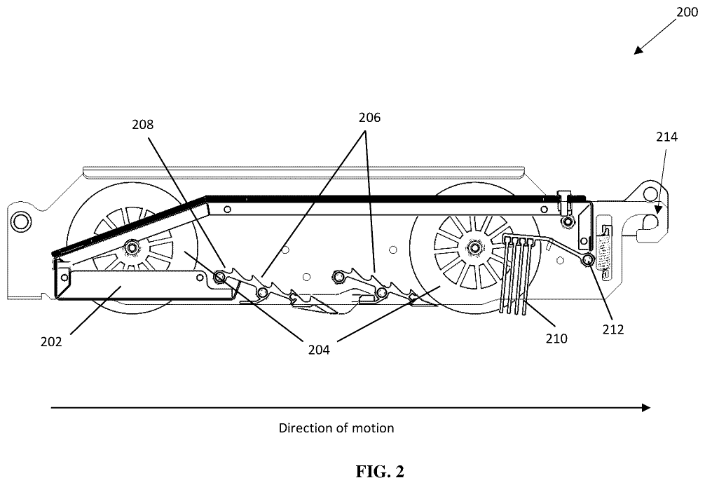

FIG. 2 is a diagram of a side view of the debris collection module. According to FIG. 2, debris collection module 200 further comprises debris bin 202 located near the proximal end and wheels 204 that ensure even wear on all wear parts. Wheels 204 are made of polyurethane, but other materials such as plastic and rubber can be considered.

According to FIG. 2, one (or more) rows of ramp assemblies 206 are placed near the center of the bottom surface of the debris collection module 200. A ramp assembly consists of a ramp and tip. The ramp assemblies 206 scoop debris from the ground surface. The ramps 206 are angled upwards towards the debris bin and further consists of rifling 208. The rifles (or rifling) 208 are configured to contain debris that does not have enough energy to get into the debris bin.

According to FIG. 2, a row of brushes 210 is placed at the leading end of the debris collection module 200. The brushes 210 disrupt and agitate small debris and allow it to be scooped by the ramps 206. The brushes can also make small particles such as sand and stones airborne, so they are easily collected by the ramps. The brushes are mounted on a pivot 212 to extend the use life of the brushes. Furthermore, wear plates if used can control further brush erosion.

According to FIG. 2, the debris collection module 200 is also shown with module connection clips 214 to link separate modules together or to a tow trailer.

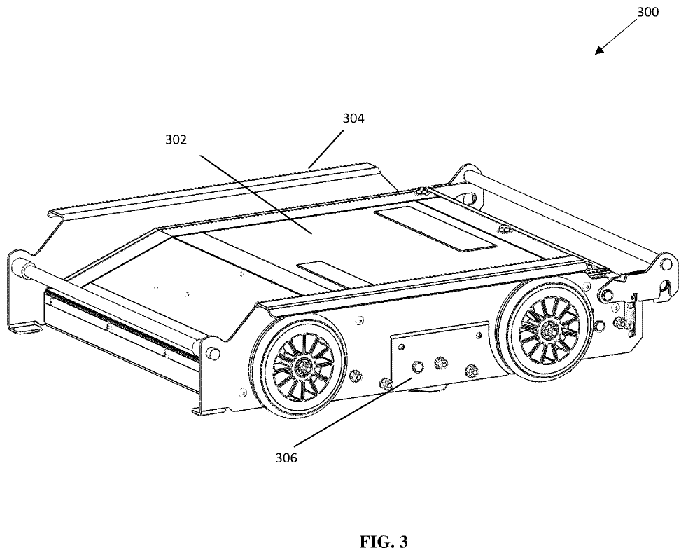

FIG. 3 is a diagram of a perspective view of the debris collection module with a cover. According to FIG. 3, debris collection module 300 a cover 302, placed on the top surface of the debris collection module 300 and is held in place with magnets for easy removal and inspection of the debris collection module. The cover also allows airflow to aid in the collection and movement of collected debris into the debris bins.

According to FIG. 3, debris collection module 300 further comprises a module stacking flange 304 and a ramp tip replacement cover 306. The module stacking flange 304 is configured to enable multiple debris collection modules to be able to stack on top of each other. The ramp tip replacement cover 306 is a plate that can be open (and closed) to allow access to the ramp tips 206 to be maintained or replaced.

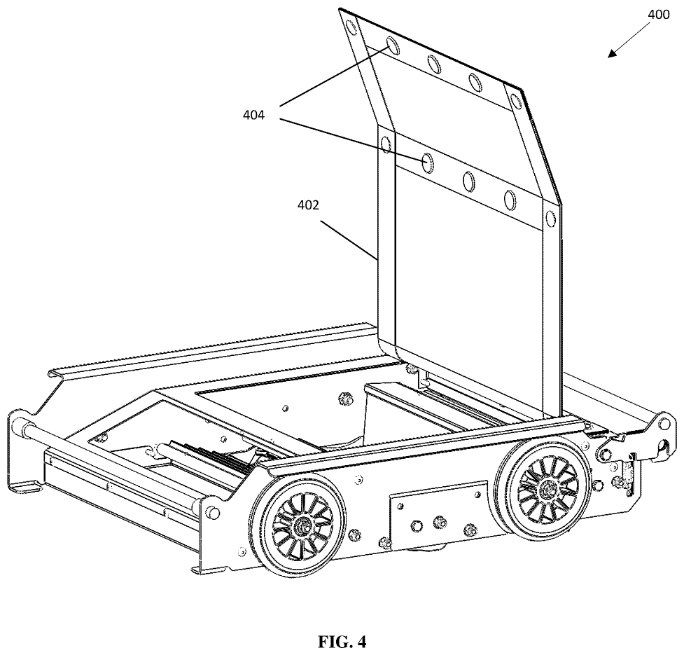

FIG. 4 is a diagram of a perspective view of the debris collection module with the cover open. According to FIG. 4, debris collection module 400 is shown having a cover 402 opened. The bottom surface of cover 402 is lined with a plurality of magnets 404. Cover 402 is kept closed with the magnets 404.

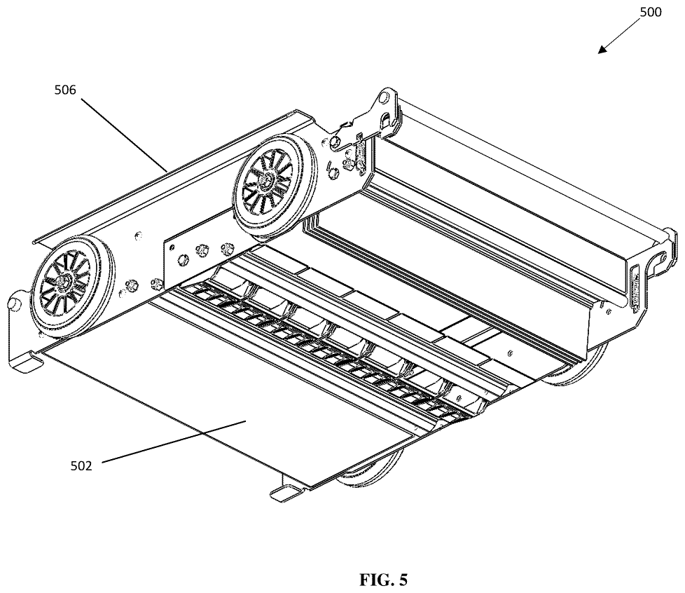

FIG. 5 is a diagram of a perspective bottom view of the debris collection module. According to FIG. 5, debris collection module 500 is shown having debris bin 502 and module stacking flange 506.

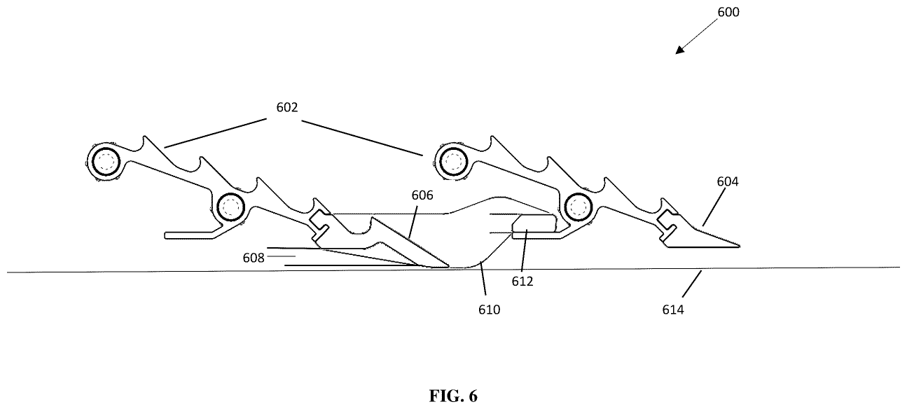

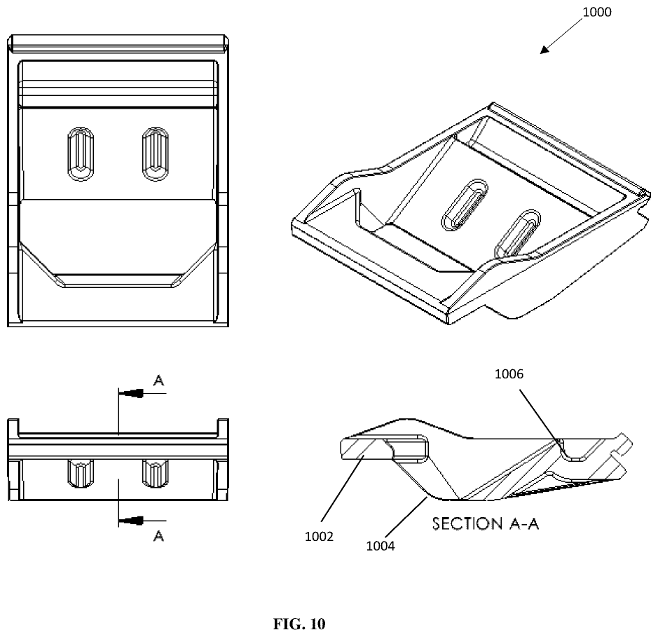

FIG. 6 is a diagram of a side view of a typical ramp layout. According to FIG. 6, the rigid ramp(s) 602 along with flexible tip(s) 604 and 606 are configured as a typical ramp layout 600. The typical ramp layout 600 comprises of a rigid ramp 602 with a slot for flexible tips (a flexible tip 604 and a flexible tip 606) to be installed, and a wear range 608. The tips (tip 604 and tip 606) can be made from a range of materials and hardnesses depending on where it will be used. Additionally, the tip(s) can have specialized features for use on different surfaces (as shown in FIGS. 10-13).

According to FIG. 6, the ramp layout 600 consists of a ramp 602 with rifling and a removeable and replaceable tip(s) 604 and 606 close to or contacting the ground surface. The tip(s) 606 has a wear range 608. The tip(s) 604 and 606 can be replaced after the tips(s) are worn.

According to FIG. 6, the lead in 610 on tip 606 guides the edge over obstructions. Furthermore, the tip 606 engages with the ramp 602 contact point 612 to reduce the chance of the tip 606 rolling under the ramp 602. Furthermore, the tip 604 remains above the ground surface 614 to not catch/snag on edges, cracks or vegetation. Tip 604 also provides an unobstructed opening from side to side of the debris collection module for collection of large debris.

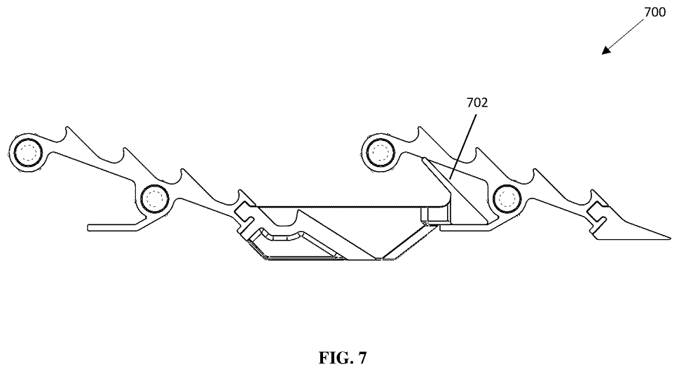

FIG. 7 is a diagram of a side view of the ramp layout with a sprung tip. According to FIG. 7, ramp layout with sprung tips 700 further comprises a flexible feature 702 to maintain downward pressure on the tip.

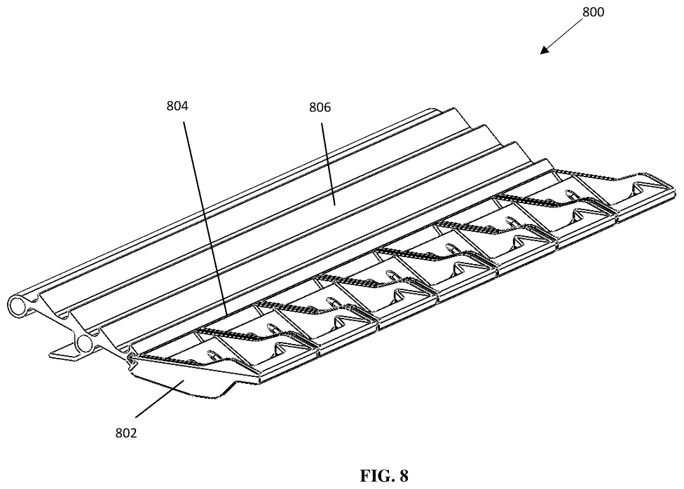

FIG. 8 is a diagram of a perspective view of a ramp assembly. According to FIG. 8, ramp assembly 800 consists of ramp 806 and tip(s) 802 are inserted into a ramp 806. Individual tip(s) 802 can be replaced if they are damaged or worn out. Tip(s) 802 are made of polyurethane material and the ramp 806 is made of aluminum material. Other materials can also be used.

According to FIGS. 6-8, a series of ramp(s) 806 with rifles held at an angle in a chassis to scoop debris from the ground surface are shown. As the debris makes its way to the top of the ramps, the debris falls into a debris bin just behind the ramp(s). A brush 210 (shown in FIG. 2) precedes the ramp(s) to disrupt small debris lodged in the ground surface. Additionally, the brush 210 serves as a curtain to restrict larger debris from being propelled forwards due to impacting the ramps and increases the chance of capturing debris.

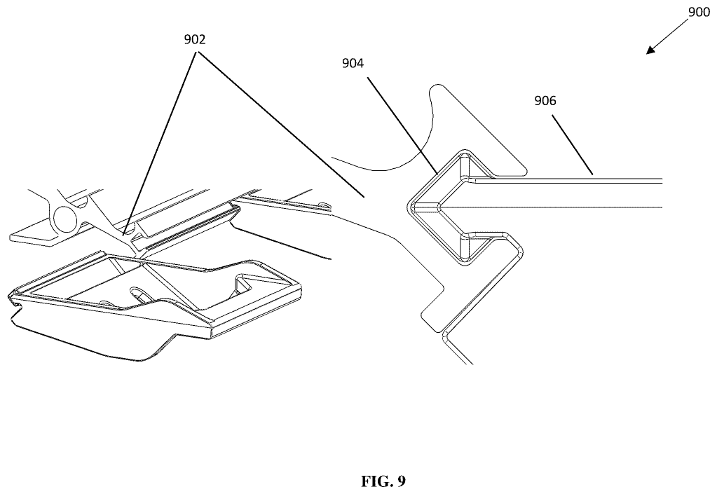

FIG. 9 is a diagram of a close-up view of the tip connection. According to FIG. 9, a close-up of tip connection detail 900 is shown to include ramp 902, tip locking feature 904 and tip 906. The tip locking feature 904 is shown to securely connect (or mate) the ramp 902 to the tip 906.

FIG. 10 is a diagram illustrating multiple views of an exemplary front supported tip. According to FIG. 10, front supported tip 1000 is shown in perspective view, top plan view, front view and section view A-A. According to section view A-A, front supported tip 1000 further comprises a surface 1002 to prevent tip from being pulled under the ramp, a lead in 1004 on the supported tip guides the edge over obstructions and a rifle 1006 to prevent debris from falling back to the ground.

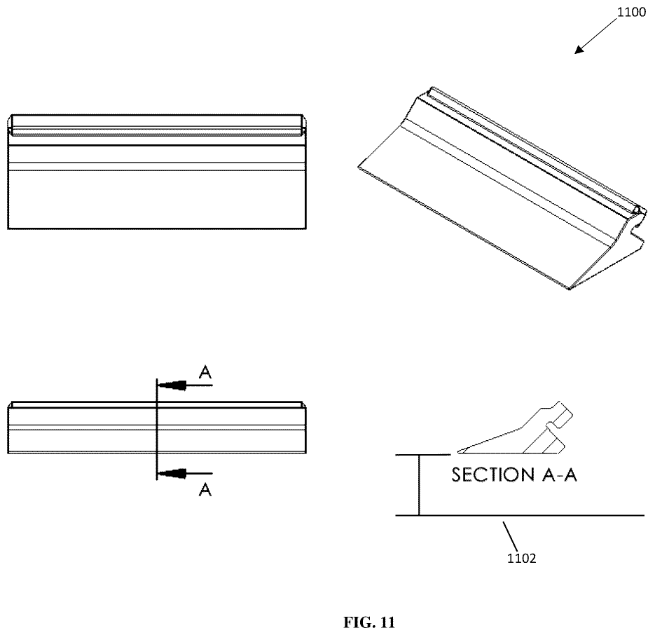

FIG. 11 is a diagram illustrating multiple views of an exemplary large debris tip. According to FIG. 11, large debris tip 1100 is shown in perspective view, top plan view, front view and section view A-A. According to section view A-A, large debris tip 1100 sits above ground 1102 to capture large debris and not interfere with an uneven surface.

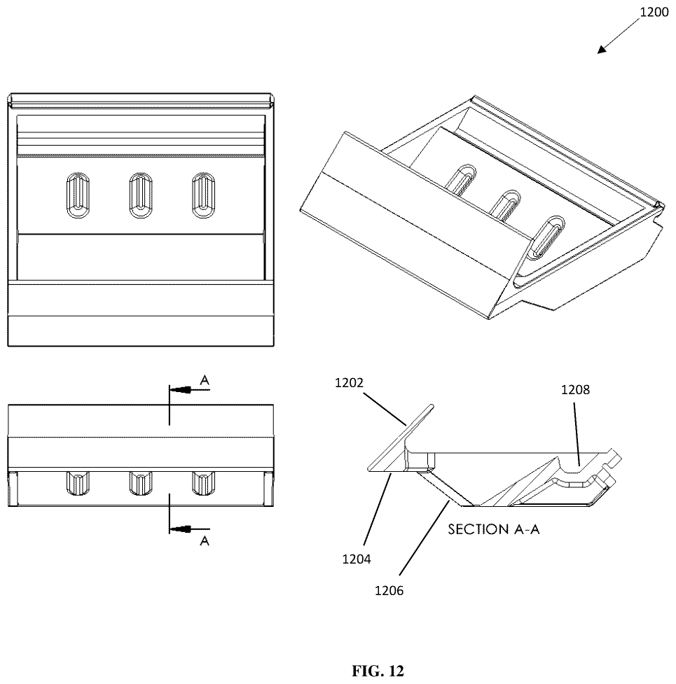

FIG. 12 is a diagram illustrating multiple views of an exemplary sprung tip. According to FIG. 12, sprung tip 1200 is shown in perspective view, top plan view, front view and section view A-A. According to section view A-A, sprung tip 1200 further comprises a flexible feature 1202 to maintain downward pressure of tip, a surface 1204 to prevent the tip from being pulled under the ramp, a lead in 1206 on the tip that guides the edge over obstructions and a rifle 1208 to prevent debris from falling back to ground.

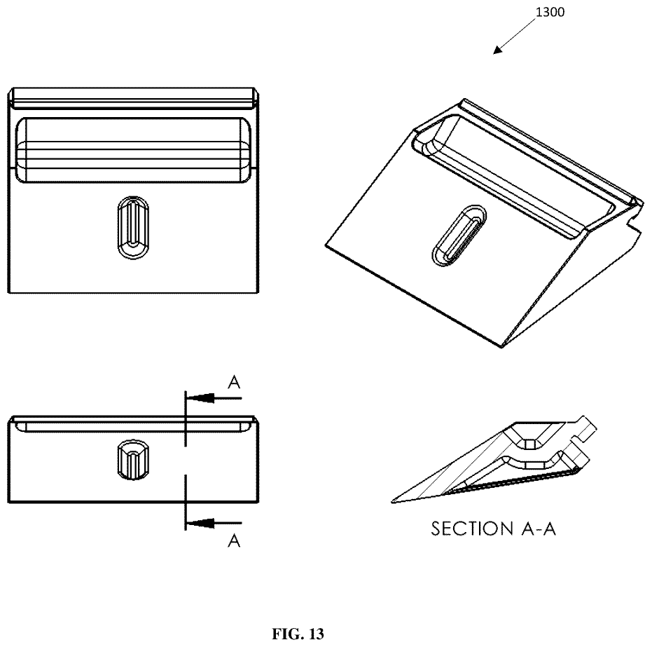

FIG. 13 is a diagram illustrating multiple views of an exemplary unsupported tip. According to FIG. 13, unsupported tip 1300 is shown in perspective view, top plan view, front view and section view A-A. The unsupported tip is designed to work best on very flat even surfaces, with minimal obstacles such as joints, grooving or vegetation.

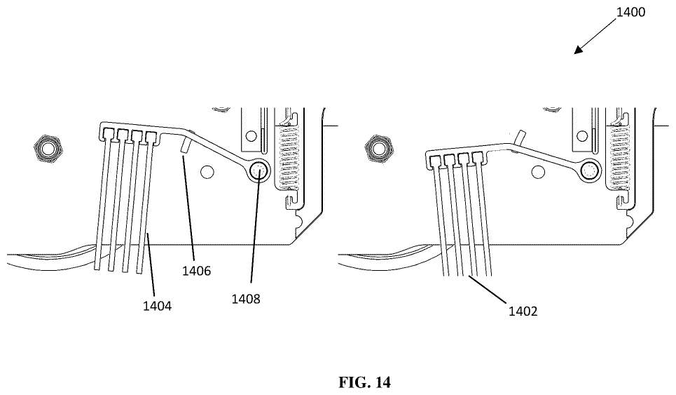

FIG. 14 is a diagram of a close-up view of the brush pivot detail. According to FIG. 14, brush pivot detail 1400 is shown replacing worn brushes 1402 with replacement brush strips 1404. Brush pivot detail 1400 further comprises a brush wear indicator 1406 attached to a brush pivot 1408.

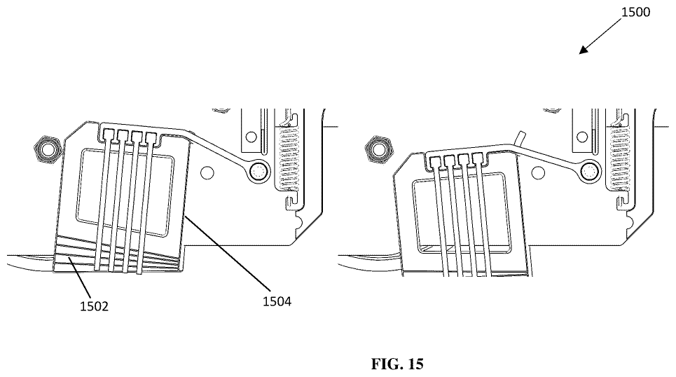

FIG. 15 is a diagram of a close-up view of the brush pivot detail with a wear plate. According to FIG. 15, brush pivot detail with wear plate 1500 is shown further comprising a brush wear indicator 1502 and brush wear plate 1504.

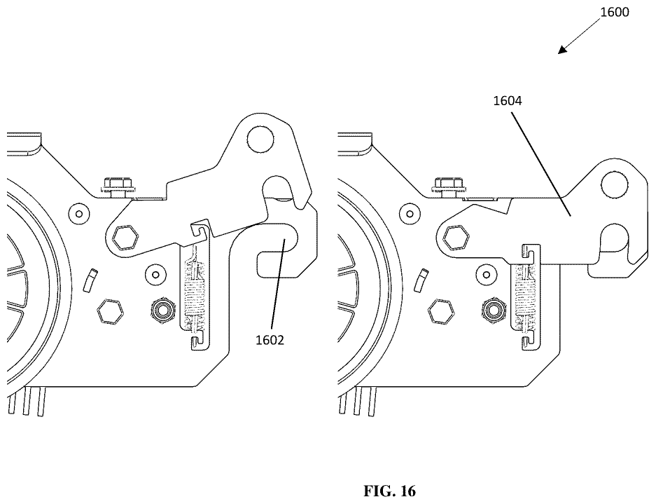

FIG. 16 is a diagram of a close-up view of the module connection clip detail. According to FIG. 16, module connection clip detail 1600 is shown having a hook 1602 and latch 1604.

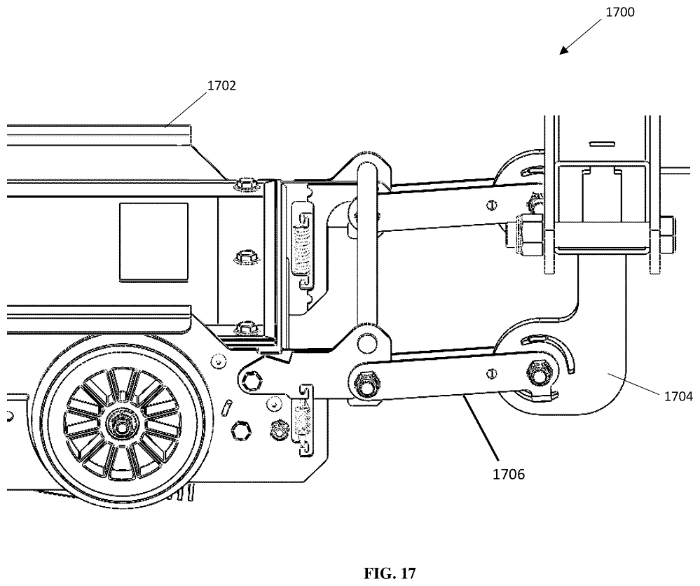

FIG. 17 is a diagram of a close-up view of the pivoting link to trailer connection link. According to FIG. 17, a pivoting link to trailer diagram 1700 is shown connecting debris collection module 1702 to tow trailer 1704 using a pivoting link 1706.

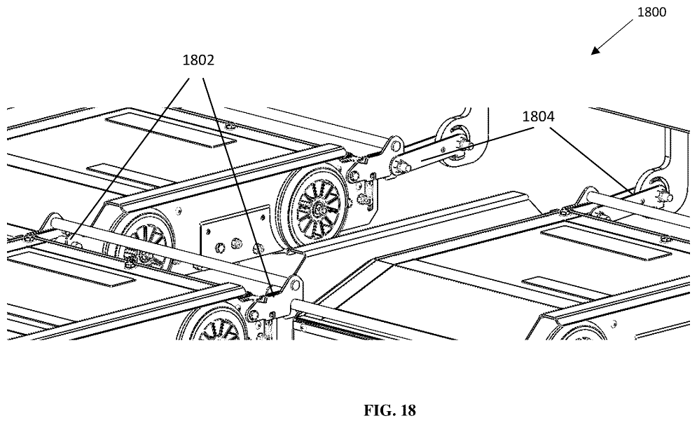

FIG. 18 is a diagram of a close-up view of connected modules. According to FIG. 18, connected modules 1800 is shown connecting debris collection modules together with module connection clips 1802 and to the tow trailer with pivoting link 1804.

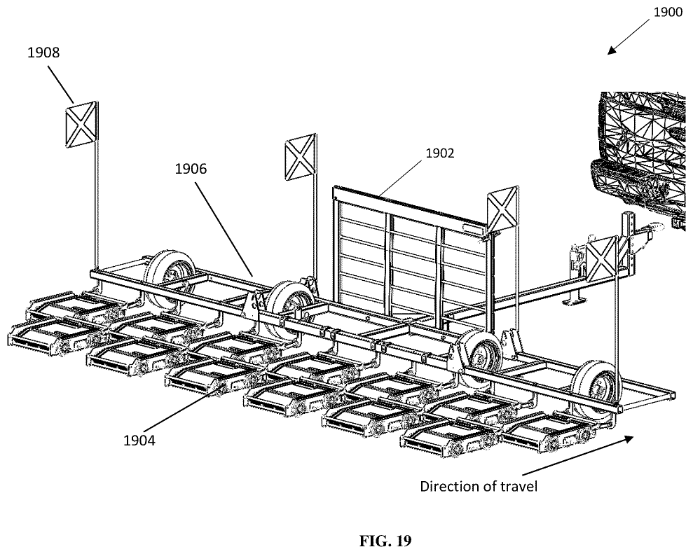

FIGS. 19 to 22 illustrate different configurations. Multiple debris collection modules can be connected to a tow trailer. The tow trailer can have folding side arms, a travel rack and a hitch to be towed by a vehicle.

FIG. 19 is a diagram of a wide sweeping configuration of a plurality of debris collection modules in operation according to a direction of travel. According to FIG. 19, the wide sweeping configuration 1900 consists of a tow trailer 1902 and multiple debris collection modules 1904 and hinged and wheeled side arms 1906 to conform to the ground.

According to FIG. 19, the debris collection modules 1904 are positioned into two rows. In this embodiment, the front row of debris collection modules 1904 are connected to tow trailer 1902 and the rear row of linked debris collection modules 1904 are connected to the front row of debris collection modules 1904 using the module connection clips. Vertical flags 1908 are also shown to indicate the width of the tow trailer 1902.

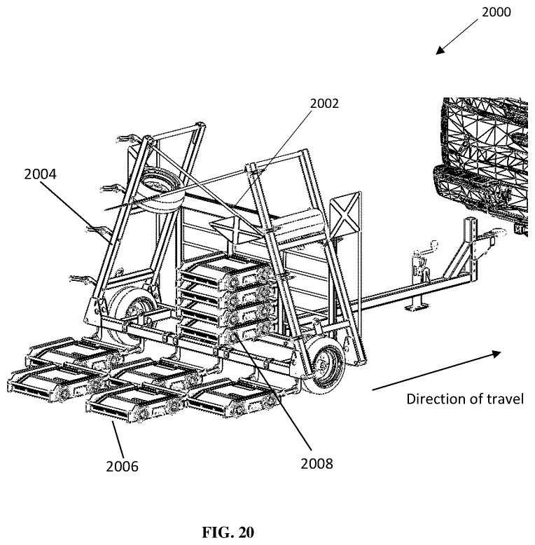

FIG. 20 is a diagram of a narrow sweeping configuration of a plurality of debris collection modules in operation. According to FIG. 20, two of the side arms 2004 of the tow trailer 2002 are folded upwards for travel or narrow sweeping. In narrow sweeping configuration, only three of the collection modules are deployed in the front row with two additional debris collection modules in the rear row. Unused debris collection modules 2008 are stored on the tow trailer.

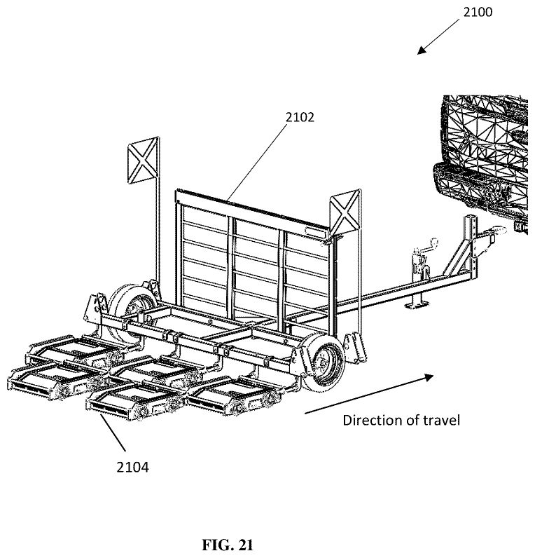

FIG. 21 is a diagram of an alternate narrow sweeping configuration of a plurality of debris collection modules in operation according to the direction of travel. According to FIG. 21, alternate narrow sweeping configuration 2100 comprises tow trailer 2102 without folding side arms. All debris collection modules 2104 are shown to be deployed.

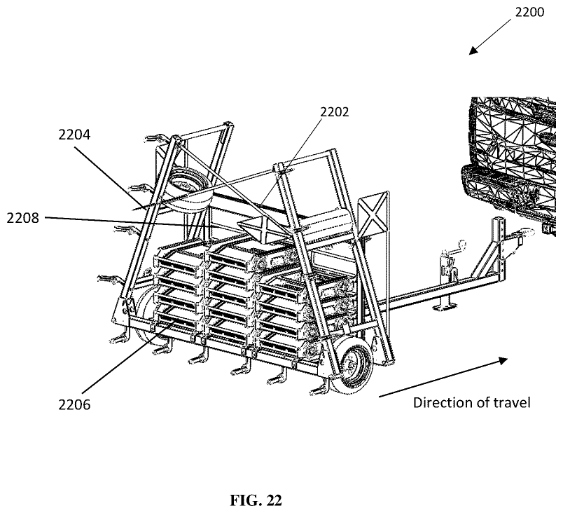

FIG. 22 is a diagram of a travel configuration of a plurality of debris collection modules in the direction of travel. According to FIG. 22, in a travel configuration 2200, the side arms 2204 of the tow trailer 2202 are folded. The debris collection modules 2206 are stacked on the travel rack 2208.

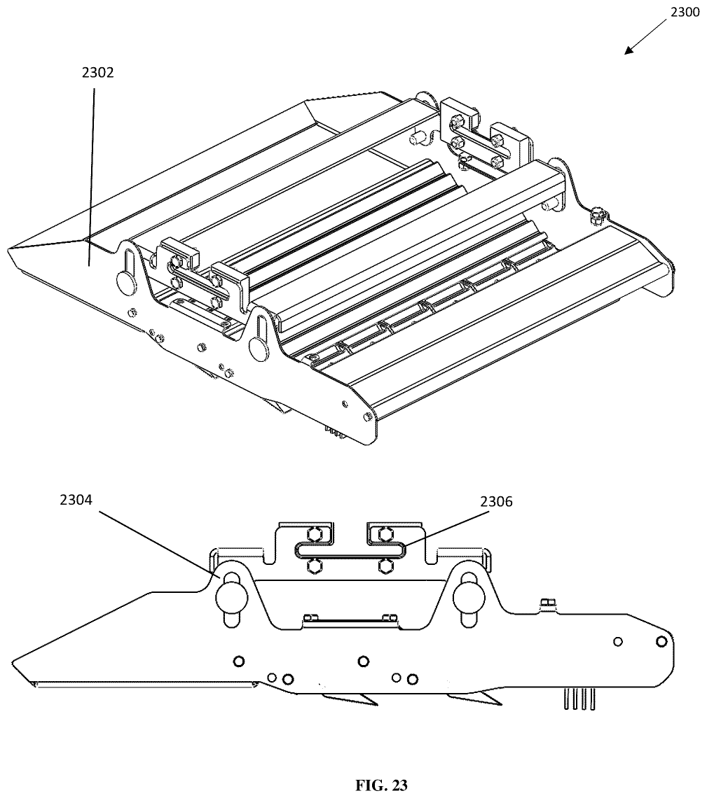

FIG. 23 is a diagram illustrating an alternate debris collection module design. According to FIG. 23, alternate debris collection module 2300 comprises a debris collection chassis 2302 without wheels. According to FIG. 23, debris collection module chassis 2302 further comprises slots 2304 to allow height adjustment of the debris collection module chassis 2302 to conform to uneven ground. Debris collection module 2300 has a module connection slot 2306 to allow for variable widths.

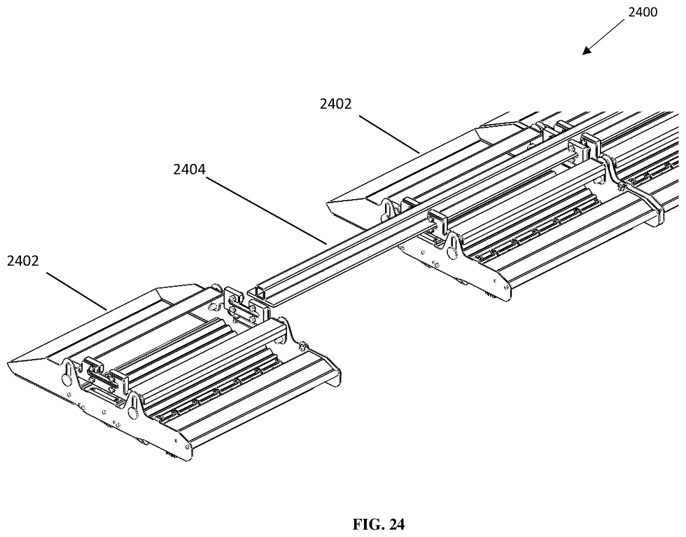

FIG. 24 is a diagram illustrating an alternate module assembly design. According to FIG. 24, alternate module assembly configuration 2400 consists of a frame 2404 to slot together multiple debris collection modules 2402.

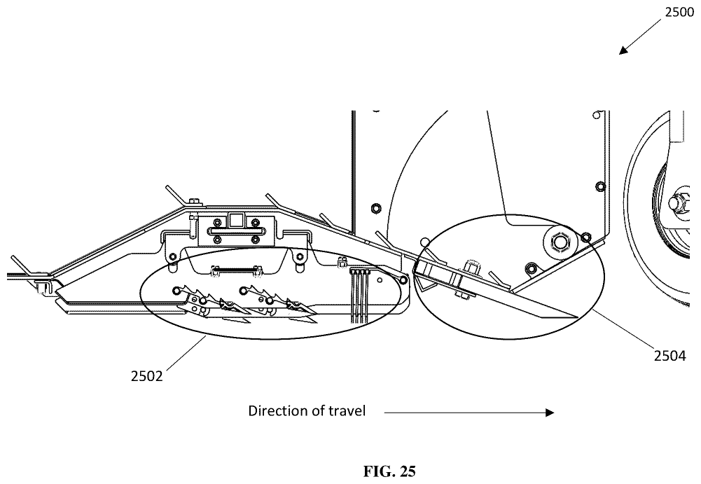

FIG. 25 is a diagram illustrating an alternate embodiment of a small debris collection system 2502 with a large debris system 2504 in operation in the direction of travel. According to FIG. 25, alternate embodiment 2500 a small debris system 2502 and a larger debris system 2504.

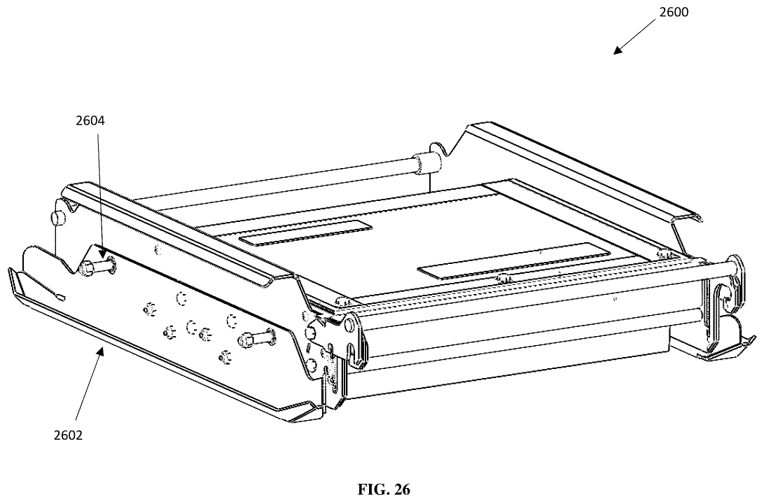

FIG. 26 is a diagram illustrating an alternate embodiment 2600 of the debris collection module with skid plates 2602 attached to the wheel mounting bolts 2604. According to FIG. 26, skid plates 2602 are affixed to the debris collection module 2600 in place of wheels.

### Unique Features

Unique features of the apparatus for collection of non-metallic and metallic foreign object debris may include one or more of the following:
Collects non-metallic debris as well as metallic debris
Modular design, allowing for easy expansion, better tracking of the ground surface as shown in FIGS. 19-21.
Removable tips allow for replacement of worn tips or installation of tip designed for different surfaces or environments as shown in FIGS. 10-13
Ramp design providing rigidity for wider and larger debris collection modules as necessary.
The frame could use skid plates rather than wheels.
Rather than linking modules together to increase width, a single wider module could be used as shown in FIGS. 23-24
Additional debris collection modules can be added for increased performance
Tip(s) can have a feature to maintain ground pressure as shown in FIG. 7
Self-contained debris bin
Debris collection modules can be stacked for transporting.
Pivoting brush increases brush life and maintains constant ground contact
Ramp profile can collect and retain debris
Easy to replace tip(s).
The top cover can be opened for easy access, inspection and clean out
Debris collection modules run on replaceable wheels
Modular design can conform to terrain and connects to a tow trailer.
Module connection clips and pivoting links provide stability and flexibility
Debris bin collects picked up debris
Parts are replaceable
Debris collection modules can be backed up

### Additional Features

Additional features of the disclosure may include:
Incorporating a rotating brush for lower speed sweeping
Incorporating a blower to disturb or direct debris
Automatic unloading of debris bin
Debris conveyor on the ramp to increase debris capacity
Independent movement of each wear parts (i.e., ramps) could lead to longer lifetimes
Ability to collect very large debris
No motors required, lower operating costs
On board debris storage on tow trailer allows debris to be contained when sweeping larger areas
A high strength magnet can precede the debris collection modules, thereby decreasing the volume of debris in the bin and extending the sweeping time before cleanout.
An additional high strength magnet after the debris collection modules to catch fine metallic particles such as steel shot which could bypass the main collection system
Different bristle materials can be used

According to the disclosure, a debris collection apparatus for the collection of non-metallic and metallic foreign object debris, configured for motion is disclosed. The debris collection apparatus comprises a chassis, a plurality of wheels mounted on the chassis, a debris bin mounted at the distal end, a brush mounted at the proximal end, a ramp and tip assembly mounted between the brush and debris bin, the ramp and tip assembly further comprising one or more rigid main ramps with rifling and side wheels. The debris collection apparatus further comprises a latch to connect the apparatus to a tow trailer.

According to the disclosure, foreign object debris is collected by the brush, tips, ramps and deposited into the debris bin of the debris collection apparatus in the direction of motion. The debris collection apparatus further comprises a cover configured to be held in place with magnets.

According to the disclosure, the brushes of the debris collection apparatus are mounted on a pivot to extend the use life of the brushes.

According to the disclosure, the one or more rows of ramps with or without tips of the debris collection apparatus are placed near the center of the bottom surface of the debris collection module. The one or more sets of ramps with or without tips scoop debris from the ground surface and wherein the ramps are angled towards the debris bin and further consists of rifling.

According to the disclosure, the wheels on the sides of the debris collection apparatus help to ensure even wear on all parts. Furthermore, the debris collection apparatus further comprises wear plates configured to control brush erosion.

According to the disclosure, the debris collection apparatus further comprises a module stacking flange configured to a multiple apparatus to be able to stack on top of each other.

According to the disclosure, the debris collection apparatus further comprises a ramp tip replacement plate that can be open and closed to allow access to the tips to be maintained or replaced. The debris collection apparatus further comprises a brush wear indicator and a brush pivot.

According to the disclosure, a tow trailer apparatus for the collection of non-metallic and metallic foreign object debris is disclosed. The tow trailer is configured for motion and further comprises a frame, a plurality of wheels, a connection mechanism to connect to a tow vehicle, a pair of foldable side arms that can be folded in a travel or narrow configuration and un-folded in a wide configuration and a connecting latch to connect the one or more collection debris modules to the tow trailer. The tow trailer apparatus is figured to store one or more collection debris modules in travel configuration and the tow trailer apparatus connects to one or more debris collection modules in a sweeping configuration in the direction of travel.

According to the disclosure, the tow trailer apparatus further comprises indicator flags. The sweeping configuration further comprises a wide sweeping and narrow sweeping configuration and wherein the side arms are deployed in wide sweeping configuration.

According to the disclosure, a ramp and tip assembly configured for the collection of non-metallic and metallic foreign object debris of a debris collection apparatus is disclosed. The ramp and tip assembly comprises a ramp connected to tip which is close to or contacting the ground surface. The ramp assembly consists of an angled ramp with rifling and a replaceable tips and the tips collect debris and direct it to the ramps and into the debris bin.

According to the disclosure, the tip of the ramp and tip assembly can be removed and replaced if worn out or damaged. The tip further tip engages with the front ramp at connection point to reduce the chance of the tip rolling under the ramp.

According to the disclosure, the ramp and tip assembly further comprise a lead in mechanism, the lead in mechanism configured to guide the tip over obstructions. The ramp and tip assembly further comprise a rigid slot that connects to the tip.

According to the disclosure, the tip of the ramp and tip assembly is made of metal, rubber or plastic. The tip remains above the ground surface to catch larger debris. Furthermore, the tip can have multiple configurations including a front supported tip (FIG. 10), a large debris tip (FIG. 11), a sprung tip (FIG. 12) and an unsupported tip (FIG. 13). The tips can be switched and replaced based on different types of debris and the desired operation.

While some embodiments or aspects of the present disclosure may be implemented in fully functioning mechanical, electrical and electrical-mechanical systems, other embodiments may be considered.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

The specific embodiments described above have been shown by way of example and understood is that these embodiments may be susceptible to various modifications and alternative forms. Further understood is that the claims are not intended to be limited to the forms disclosed, but to cover all modifications, equivalents, and alternatives falling within the spirit and scope of this disclosure. While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, various changes and modifications in form, material, workpiece, and fabrication material detail may be made, without departing from the spirit and scope of the present disclosure, as set forth in the appended claims, as may be apparent to those of ordinary skill in the art, are also encompassed by the present disclosure.

What is claimed is:

1. A debris collection apparatus for the collection of non-metallic and metallic foreign object debris, configured for motion, the debris collection apparatus comprising:
a chassis;
a plurality of wheels mounted on the chassis;
a debris bin mounted at the distal end;
a brush mounted at the proximal end;
a ramp and tip assembly mounted between the brush and debris bin, the ramp and tip assembly further comprising:
one or more rigid main ramps with rifling and side wheels;
a latch to connect the apparatus to a tow trailer;
wherein foreign object debris is collected by the brush, tips, ramps and deposited into the debris bin in the direction of motion.

2. The apparatus of claim 1 further comprising a cover configured to be held in place with magnets.

3. The apparatus of claim 1 wherein the brushes are mounted on a pivot to extend the use life of the brushes.

4. The apparatus of claim 1 wherein one or more rows of ramps with or without tips are placed near the center of the bottom surface of the debris collection module.

5. The apparatus of claim 1 wherein one or more sets of ramps with or without tips scoop debris from the ground surface and wherein the ramps are angled towards the debris bin and further consists of rifling.

6. The apparatus of claim 1 wherein the wheels on the sides of the apparatus help to ensure even wear on all parts.

7. The apparatus of claim 1 further comprising wear plates configured to control brush erosion.

8. The apparatus of claim 1 further comprising a module stacking flange configured to a multiple apparatus to be able to stack on top of each other.

9. The apparatus of claim 1 further comprising a ramp tip replacement plate that can be open and closed to allow access to the tips to be maintained or replaced.

10. The apparatus of claim 1 further comprising a brush wear indicator and a brush pivot.

11. A tow trailer apparatus for the collection of non-metallic and metallic foreign object debris, configured for motion, the tow trailer, further comprising:
a frame;
a plurality of wheels;
a connection mechanism to connect to a tow vehicle;
a pair of foldable side arms that can be folded in a travel or narrow configuration and un-folded in a wide configuration; and
a connecting latch to connect the one or more collection debris modules to the tow trailer;
wherein the tow trailer apparatus is figured to store one or more collection debris modules in travel configuration;
wherein the tow trailer apparatus connects to one or more debris collection modules in a sweeping configuration in the direction of travel.

12. The tow trailer apparatus of claim 11 further comprising indicator flags.

13. The tow trailer apparatus of claim 11 wherein the sweeping configuration further comprises a wide sweeping and narrow sweeping configuration and wherein the side arms are deployed in wide sweeping configuration.

14. A ramp and tip assembly configured for the collection of non-metallic and metallic foreign object debris, the ramp and tip assembly comprising:
a ramp connected to tip which is close to or contacting the ground surface;
wherein the ramp assembly consists of an angled ramp with rifling and a replaceable tip;
wherein the tips collect debris and direct it to the ramps and into the debris bin.

15. The ramp and tip assembly of claim 14 wherein the tip can be removed and replaced if worn out or damaged.

16. The ramp and tip assembly of claim 14 wherein the tip engages with the front ramp at connection point to reduce the chance of the tip rolling under the ramp.

17. The ramp and tip assembly of claim 14 further comprising a lead in mechanism, the lead in mechanism configured to guide the tip over obstructions.

18. The ramp and tip assembly of claim 14 further comprising a rigid slot that connects to the tip.

19. The ramp and tip assembly of claim 14 wherein the tip is made of a metal, rubber or plastic.

20. The ramp and tip assembly of claim 14 wherein the tip remains above the ground surface to catch larger debris.
